(19) United States
(12) Patent Application Publication
(10) Pub. No.: US 2010/0182539 A1
(43) Pub. Date: Jul. 22, 2010

(54) BACKLIGHT UNIT AND LIQUID CRYSTAL DISPLAY

(76) Inventors: Chiaki Ohyama, Osaka (JP); Masashi Miwa, Osaka (JP)

Correspondence Address: BIRCH STEWART KOLASCH & BIRCH, PO BOX 747, FALLS CHURCH, VA, 22040-0747, US

(21) Appl. No.: 12/601,888

(22) PCT Filed: Jan. 18, 2008
(86) PCT No.: PCT/JP2008/050567

§ 371 Date: Nov. 25, 2009

(30) Foreign Application Priority Data
Jun. 6, 2007 (JP) 2007-150146

(51) Int. Cl. G02F 1/1335; F21V 7/04

(52) U.S. Cl. 349/65; 362/606

(57) ABSTRACT

A plurality of LEDs (11) in an LED group (GP) are arranged in the longitudinal direction of an incident surface (21s) of a light guide plate (21) to form LED rows (12a and 12b). These two LED rows (12a and 12b) are arranged in a direction intersecting the incident surface (21s).

### TECHNICAL FIELD

The present invention relates to a backlight unit that emits light to a liquid crystal display panel and a liquid crystal display incorporating such a backlight unit.

### BACKGROUND ART

Generally, in a display panel (liquid crystal display panel) using liquid crystal, the liquid crystal itself emits no light. Thus, a liquid crystal display incorporating a liquid crystal display panel takes in sunlight or the like as external light, and utilizes the external light to display various images on the liquid crystal display panel. Then, keeping in mind that it may be impossible to take in external light, it is preferable that the liquid crystal display include a device (backlight unit) which emits light to the liquid crystal.

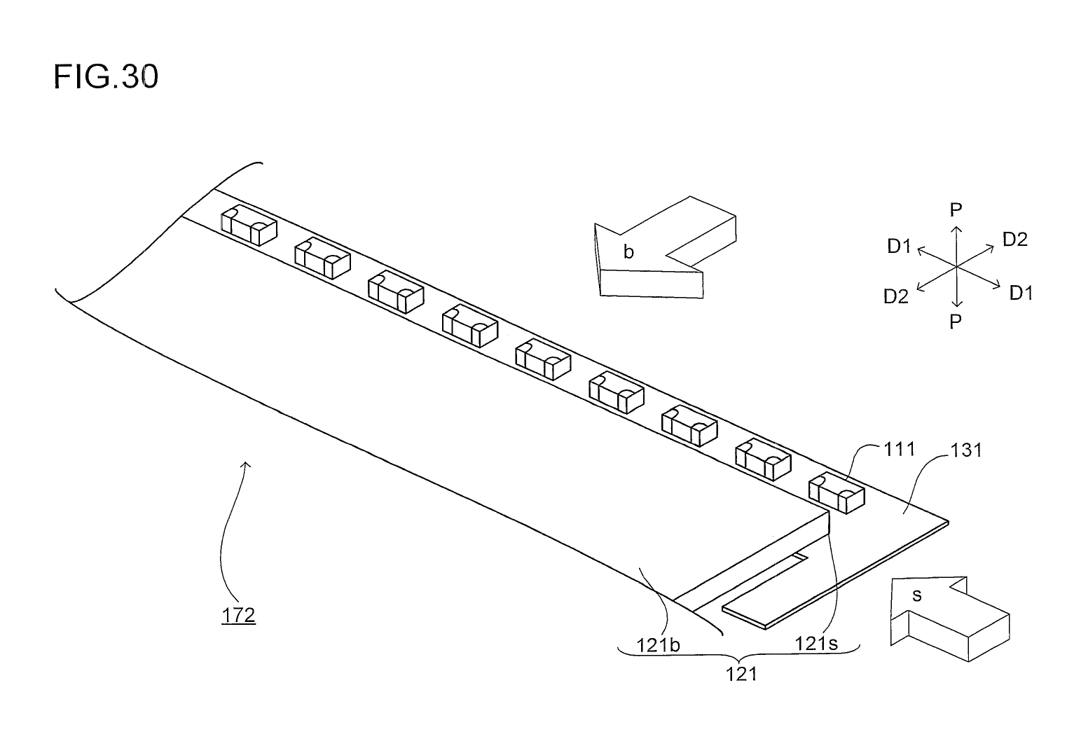

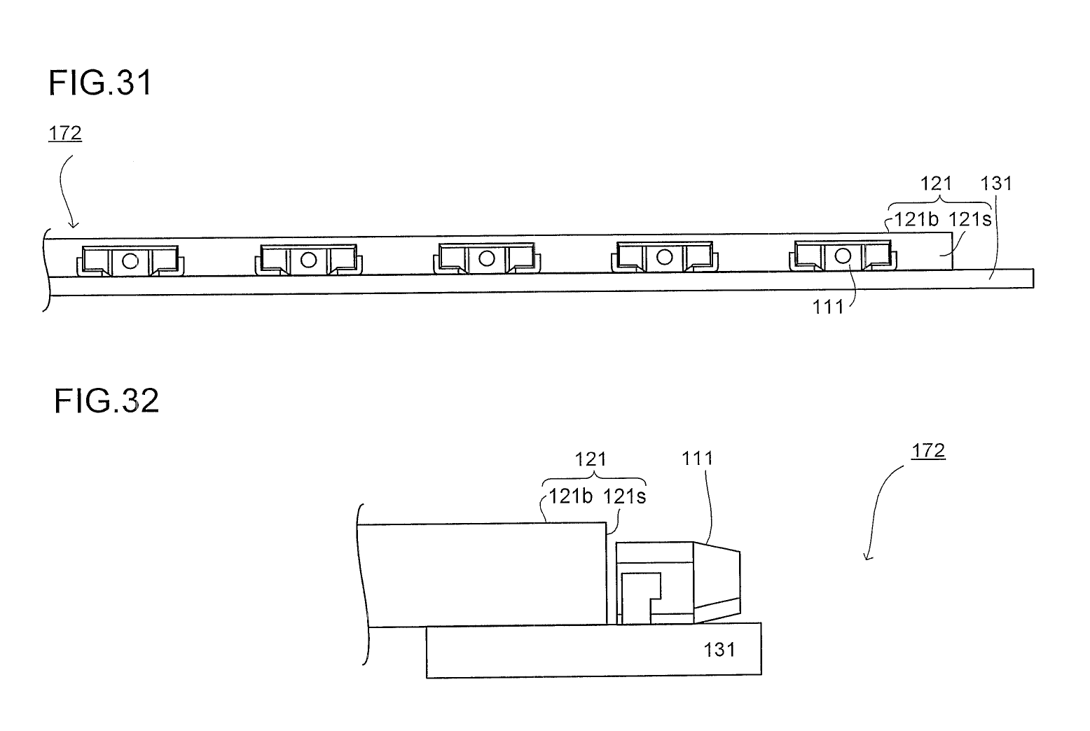

As an example, a backlight unit 172 shown in FIGS. 30 to 32 is taken [FIG. 31 is a plan view as seen from the back surface of LEDs 111 shown in FIG. 30 (see arrow “b”); FIG. 32 is a plan view as seen from the side surface of the LEDs 11 shown in FIG. 30 (see arrow “s”)]. In the backlight unit 172, the LEDs 111 aligned on a FPC (flexible printed circuit) board 131 emit light to a side surface of a light guide plate 121 (an incident surface 121s), and the light guide plate 121 mixes the incident light and emits planar light from its top surface 121b.

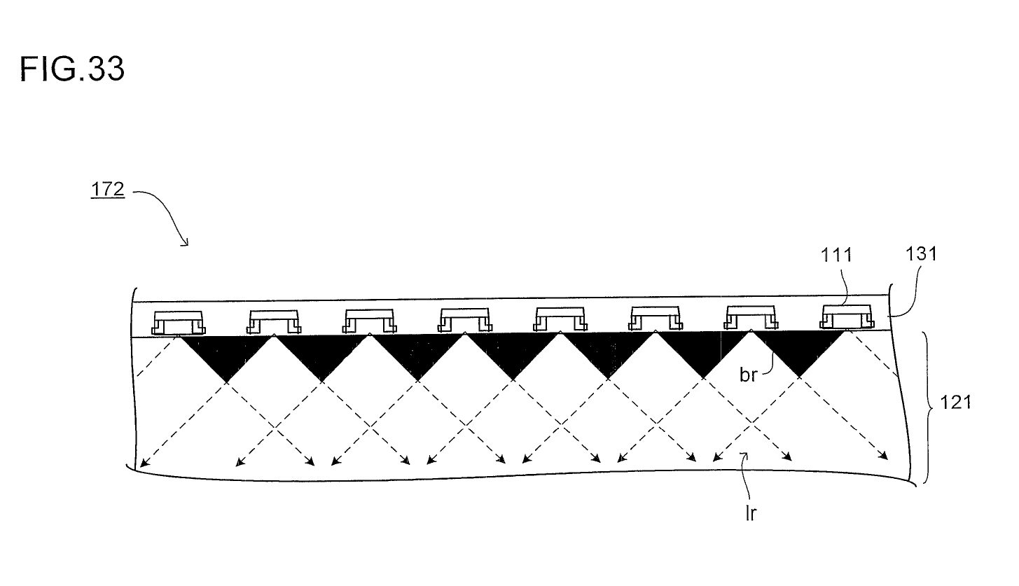

However, in the light guide plate 121 of the backlight unit 172, as shown in FIG. 33, portions (dark regions br) which light from the LEDs 111 does not enter are produced between the adjacent LEDs 111. Specifically, the dark regions br and other regions (portions to which light from the LEDs 111 is emitted; light regions lr) are produced in the light guide plate 121.

The production of the dark regions br and the light regions lr within the light guide plate 121 causes variations in brightness of light (backlight) from the backlight unit 172. When the backlight having variations in brightness enters the liquid crystal panel, an image displayed on the liquid crystal display panel is affected by the variations in brightness, with the result that the image quality of the liquid crystal display is degraded.

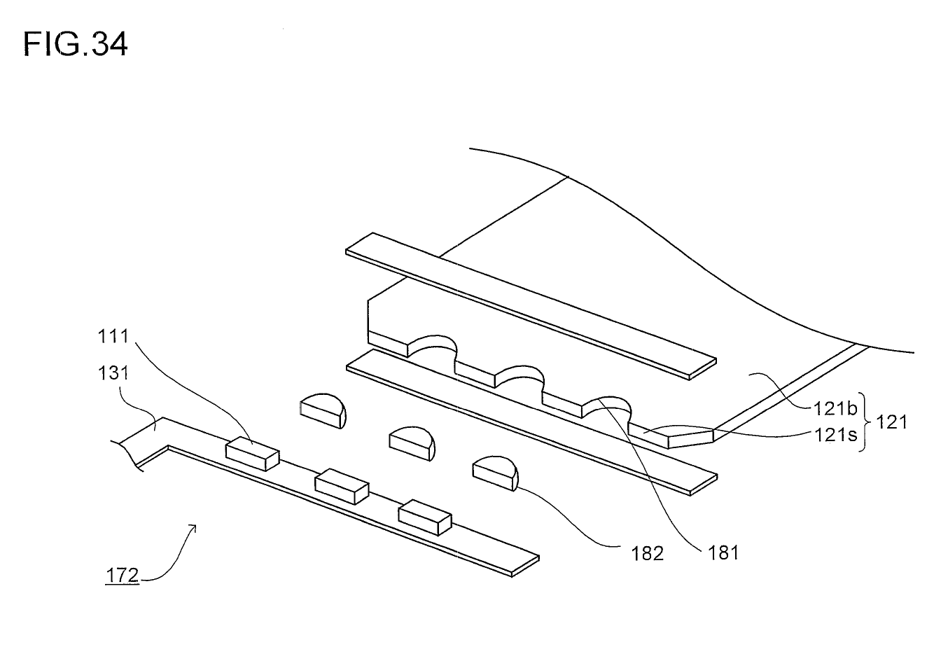

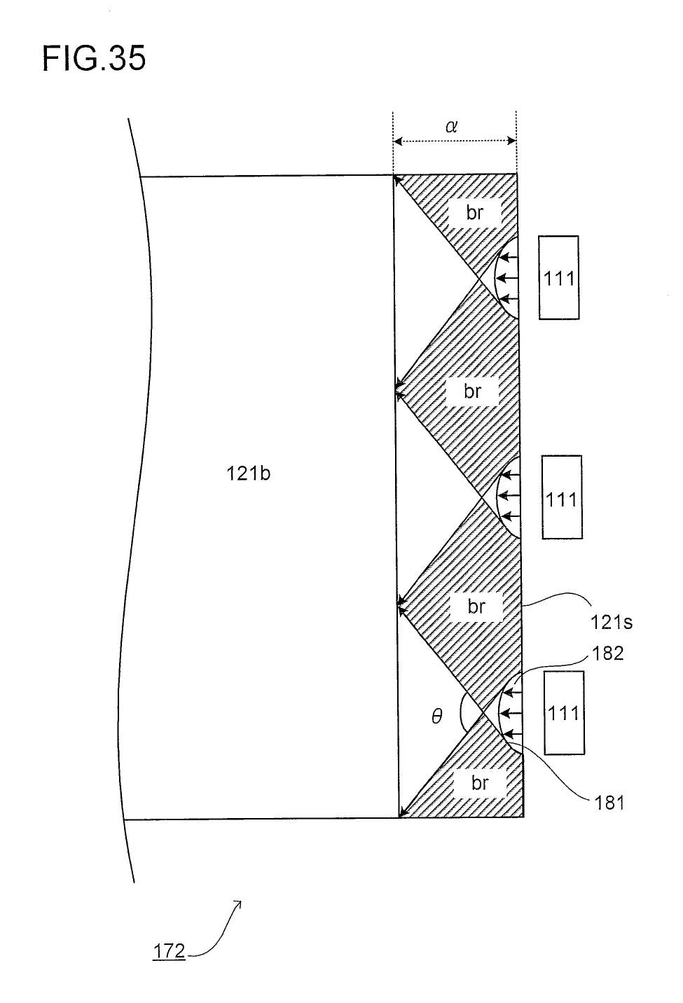

To overcome the foregoing problem, various backlight units for reducing the dark regions br are developed. An example of them is a backlight unit 172 shown in FIGS. 34 and 35 and disclosed in patent document 1.

This backlight unit 172 has grooves 181 formed in the incident surface 121s of the light guide plate 121, includes lenses 182 that are accommodated in the grooves 181 and emits light of the LEDs 111 to the lenses 182. In particular, the lenses 182 in the backlight unit 172 contain a diffusion agent that diffuses and emits the incident light.

Thus, the diffusion angle θ of the light that is emitted from the lenses 182 is relatively widely diffused, and the depth a of the dark regions br is reduced. Consequently, the area of the dark regions br is decreased, and variations in brightness of backlight caused by the presence of the dark regions br and the light regions lr are reduced.

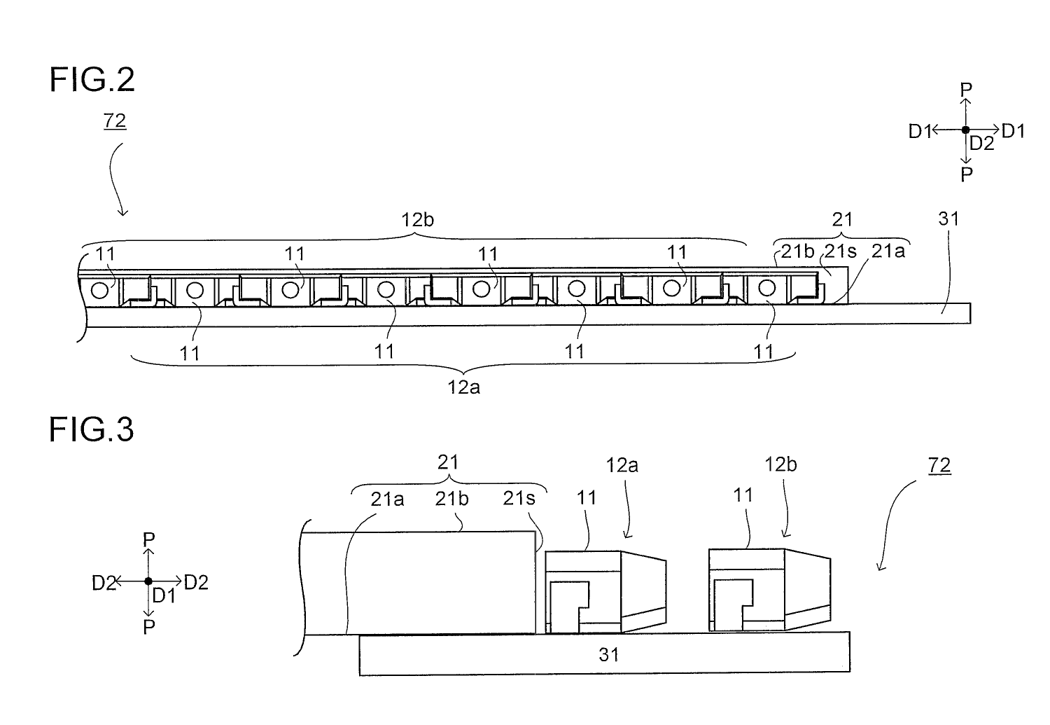

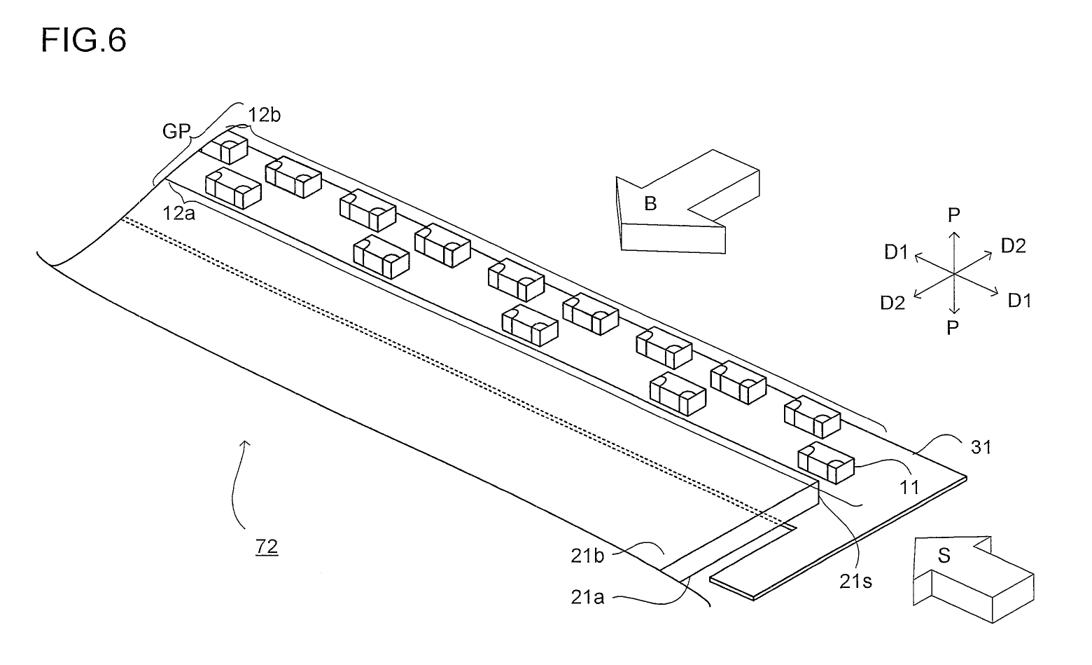

Patent document 1: JP-A-2006-108606 (see FIGS. 2 and 6 and other figures).

### DISCLOSURE OF THE INVENTION

### Problems to be Solved by the Invention

Disadvantageously, however, in the backlight unit 172, the grooves 181 needs to be formed in the incident surface 121s of the light guide plate 121. Moreover, the lenses 182 need to have such a size that they can be accommodated in the grooves 181. For this reason, the configuration of the backlight unit 172 is complicated, and the number of manufacturing processes is increased. Furthermore, since the lenses 182 contain the diffusion agent, they are more likely to be expensive, and this increases the cost of the backlight unit 172.

In view of the foregoing, the present invention is designed. An object of the present invention is to provide a backlight unit that has a simple configuration and that can reduce variations in brightness of backlight and a liquid crystal display incorporating such a backlight unit.

### Means for Solving the Problem

A backlight unit includes: a light-emitting element group including a plurality of light-emitting elements; and a light guide plate having an incident surface which light from the light-emitting elements enters. In the backlight unit, the light-emitting element group includes a plurality of light-emitting element rows having the light-emitting elements aligned, and the plurality of light-emitting element rows are aligned in a direction intersecting the incident surface of the light guide plate.

In this case, for example, as compared with a light-emitting element group including only one light-emitting element row, since the number of light-emitting element rows is large, the number of light-emitting elements is increased. Moreover, since the light-emitting element rows in the light-emitting element group are arranged in the direction intersecting the incident surface of the light guide plate, the degree to which the light-emitting elements in the light-emitting element group are brought close to each other is increased as compared with the degree to which the light-emitting elements in the light-emitting element group including only one light-emitting element row are brought close to each other. Hence, the dark region produced between the light-emitting elements is more likely to be small, and variations in brightness of light (backlight) emitted from the backlight unit are unlikely to occur.

Preferably, in particular, in the light-emitting element rows aligned in the light-emitting element group, between the light-emitting elements in one of the light-emitting element rows, the light-emitting elements in another of the light-emitting element rows emit light.

In this way, the light-emitting elements in the another of the light-emitting element rows emit light to the dark region produced between the light-emitting elements in the one of the light-emitting element rows, and thus the dark region is further reduced.

The number of the light-emitting elements in the another of the light-emitting element rows that emit light between the light-emitting elements in the one of the light-emitting element rows may be one or more than one.

Preferably, when the above number is one, in the light-emitting element rows aligned in the light-emitting element group, for example, a pitch between the light-emitting elements in the one of the light-emitting element rows is equal to a pitch between the light-emitting elements in the another of the light-emitting element rows, and the first optical paths of the light-emitting elements in the one of the light-emitting element rows and the second optical paths of the light-emitting elements in the another of the light-emitting element rows are alternately aligned.

When the number of light-emitting elements in the another of the light-emitting element rows that emit light between the light-emitting elements in the one of the light-emitting element rows is more than one, in the light-emitting element rows aligned in the light-emitting element group, for example, a pitch between the light-emitting elements in the one of the light-emitting element rows is different from a pitch between the light-emitting elements in the another of the light-emitting element rows. Preferably, in the light-emitting element group, the first optical paths of the light-emitting elements in the one of the light-emitting element rows and the second optical paths of the light-emitting elements in the another of the light-emitting element rows are aligned and the aligned optical paths include a portion where the optical paths of the same type are successively aligned.

In the backlight unit, a board on which the one of the light-emitting element rows is mounted and a board on which the another of the light-emitting element rows is mounted may be separate from each other. Preferably, the board on which the one of the light-emitting element rows is mounted faces the light-emitting surface of the light guide plate, and the board on which the another of the light-emitting element rows is mounted faces the non-light-emitting surface opposite the light-emitting surface.

In the backlight unit, a continuous board unit may include the board on which the one of the light-emitting element rows is mounted and the board on which the another of the light-emitting element rows is mounted. Preferably, the board unit winds around the light-emitting surface of the light guide plate and the non-light-emitting surface opposite the light-emitting surface, and the board on which the one of the light-emitting element rows is mounted faces the light-emitting surface, and the board on which the another of the light-emitting element rows is mounted faces the non-light-emitting surface.

In the backlight unit, at least one of the one of the light-emitting element rows and the another of the light-emitting element rows may be formed by mixing and aligning light-emitting elements mounted on separate boards. Preferably, one of the separate boards faces the light-emitting surface of the light guide plate and the other of the separate boards faces the non-light-emitting surface opposite the light-emitting surface.

In the backlight unit, the light-emitting elements in the light-emitting element group may be distributed on a light-emitting-surface-side board facing the light-emitting surface of the light guide plate and a non-light-emitting-surface-side board facing the surface opposite the light-emitting surface, and may be mounted in a row on each of the boards. In the backlight unit, the light-emitting-surface-side board and the non-light-emitting-surface-side board are brought close to each other with the mounting surfaces thereof opposite each other such that the light-emitting elements on the light-emitting-surface-side board and the light-emitting elements on the non-light-emitting-surface-side board are alternately arranged.

In this backlight unit, the light-emitting elements on the light-emitting-surface-side board and the light-emitting elements on the non-light-emitting-surface-side board that are alternately arranged are preferably disposed in a row. However, no restrictions are imposed by this; the light-emitting elements on the light-emitting-surface-side board and the light-emitting elements on the non-light-emitting-surface-side board that are alternately arranged may be disposed in a zigzag pattern.

A continuous board unit may include the light-emitting-surface-side board and the non-light-emitting-surface-side board.

Moreover, according to another aspect of the present invention, there is provided a liquid crystal display including the above-described backlight unit and a liquid crystal display panel receiving light emitted from the backlight unit.

### Advantages of the Invention

With the backlight of the present invention, irrespective of its simple configuration in which a plurality of light-emitting element rows are included in the light-emitting group, it is possible to reduce variations in brightness of backlight.

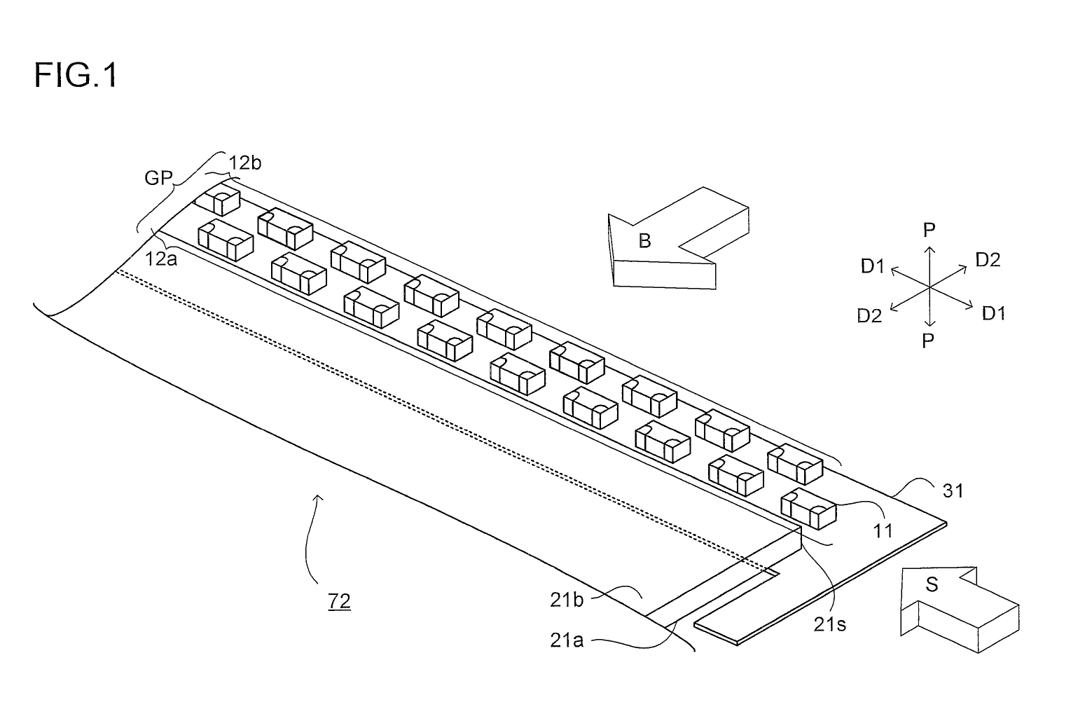

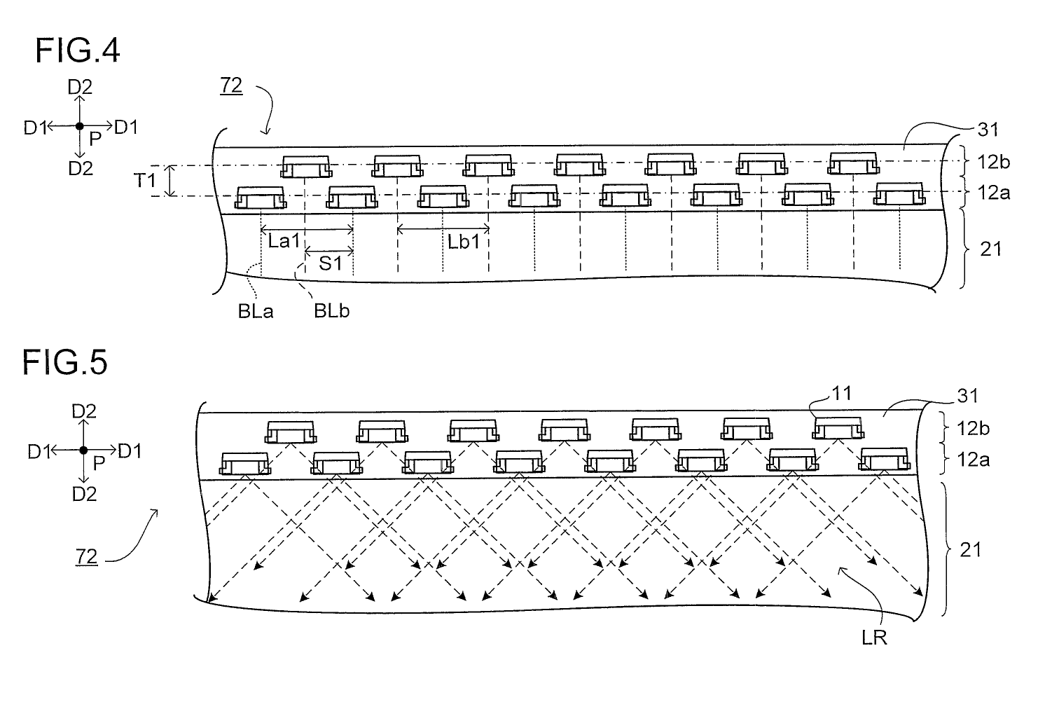

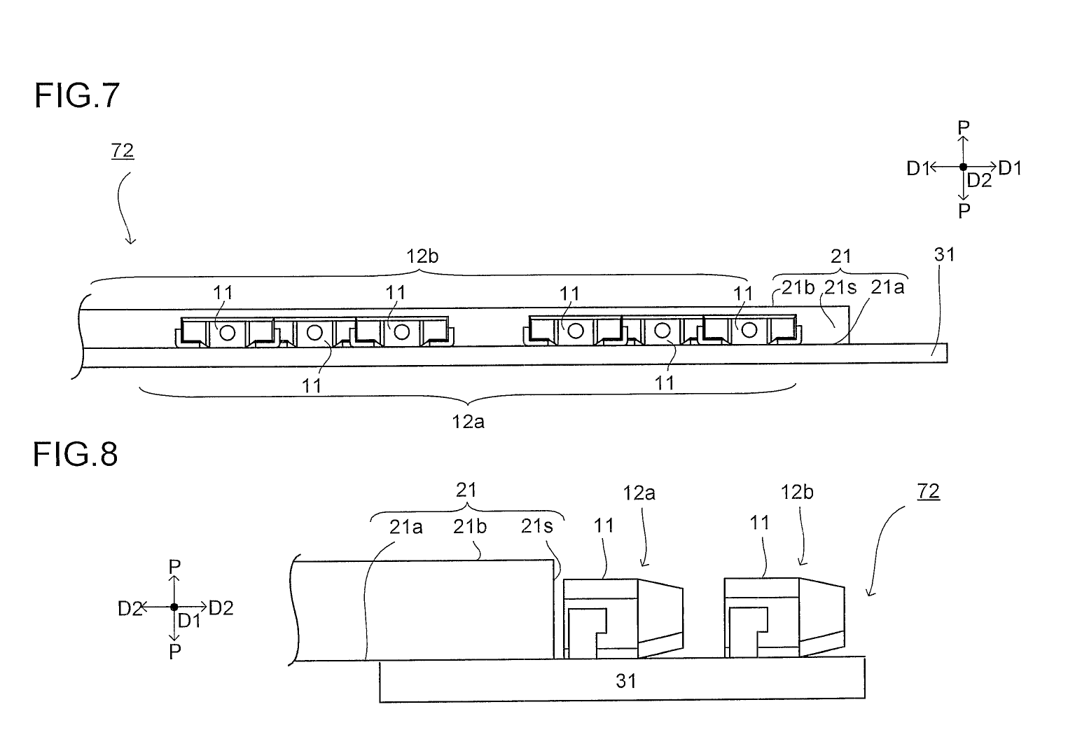

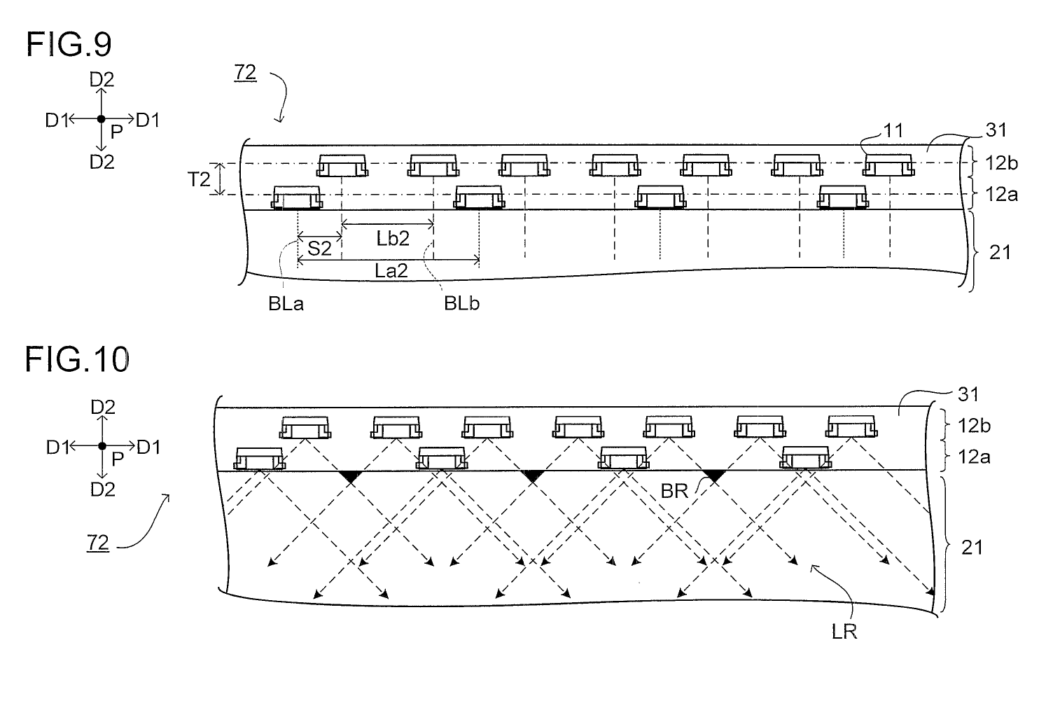

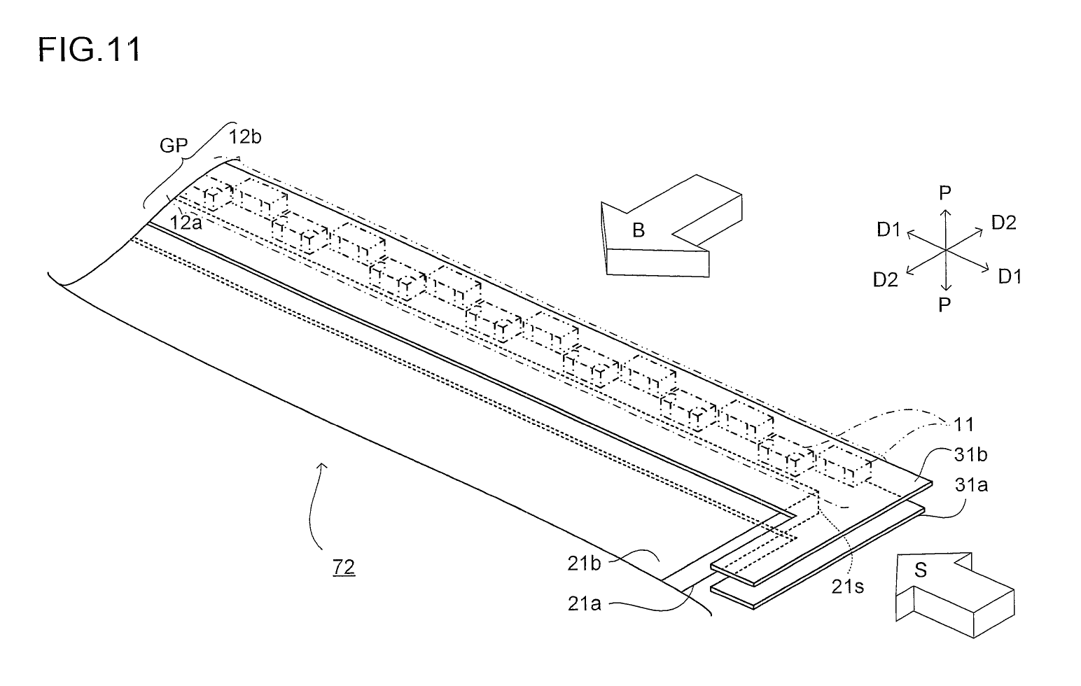

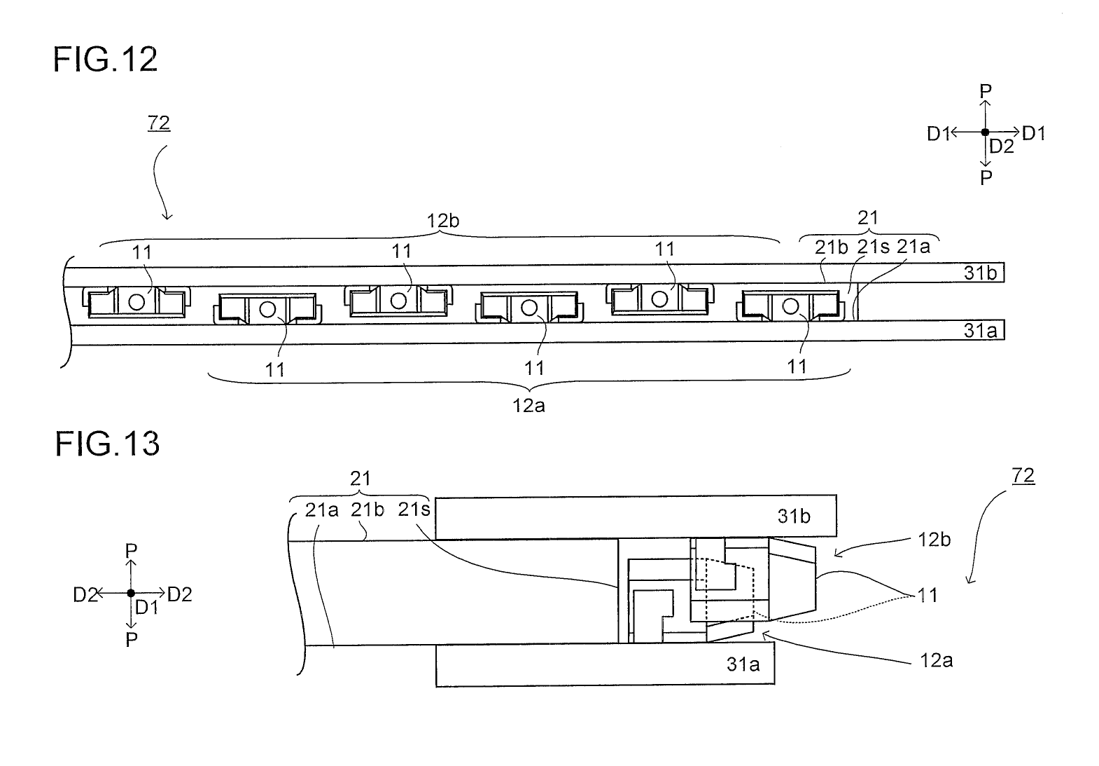

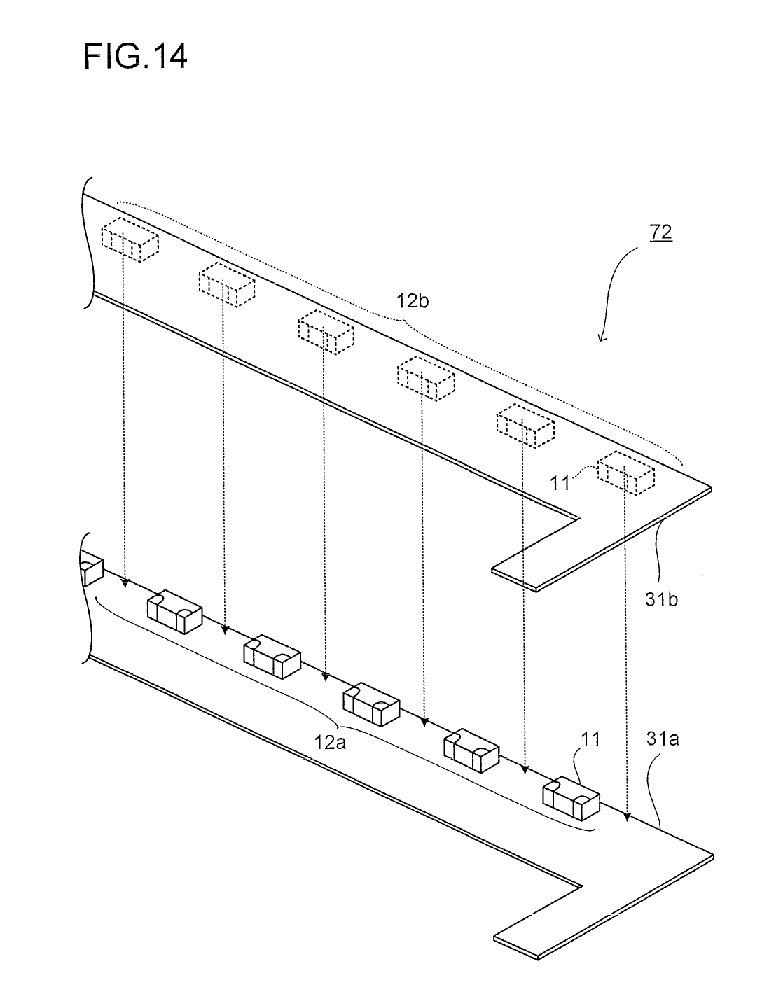

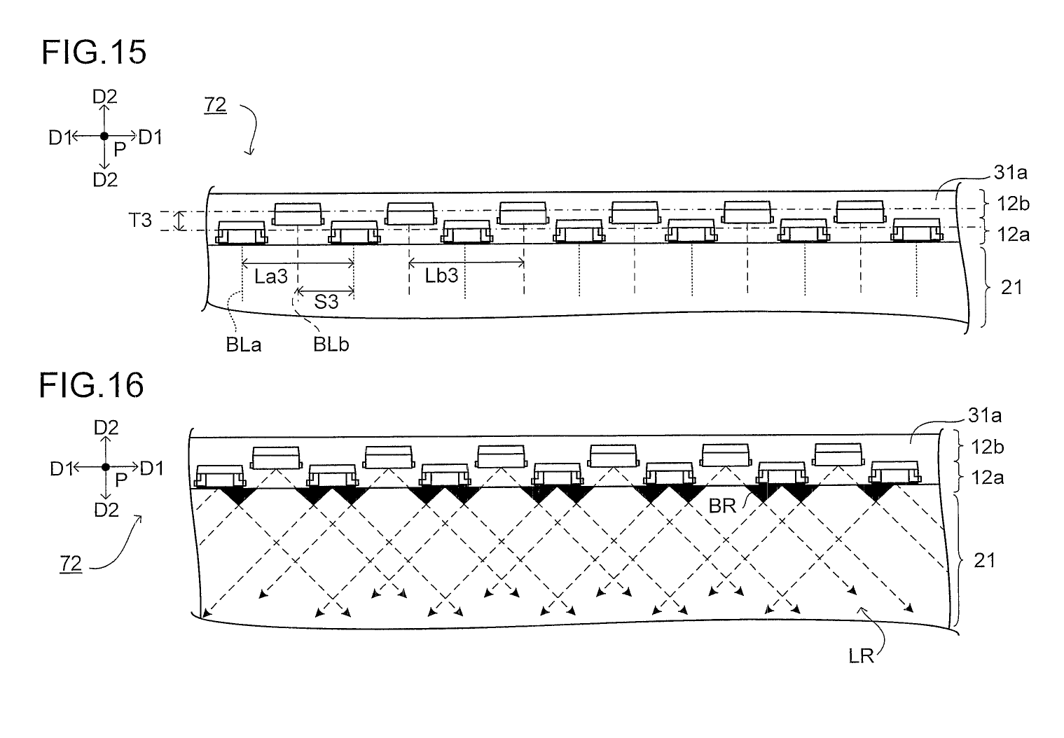

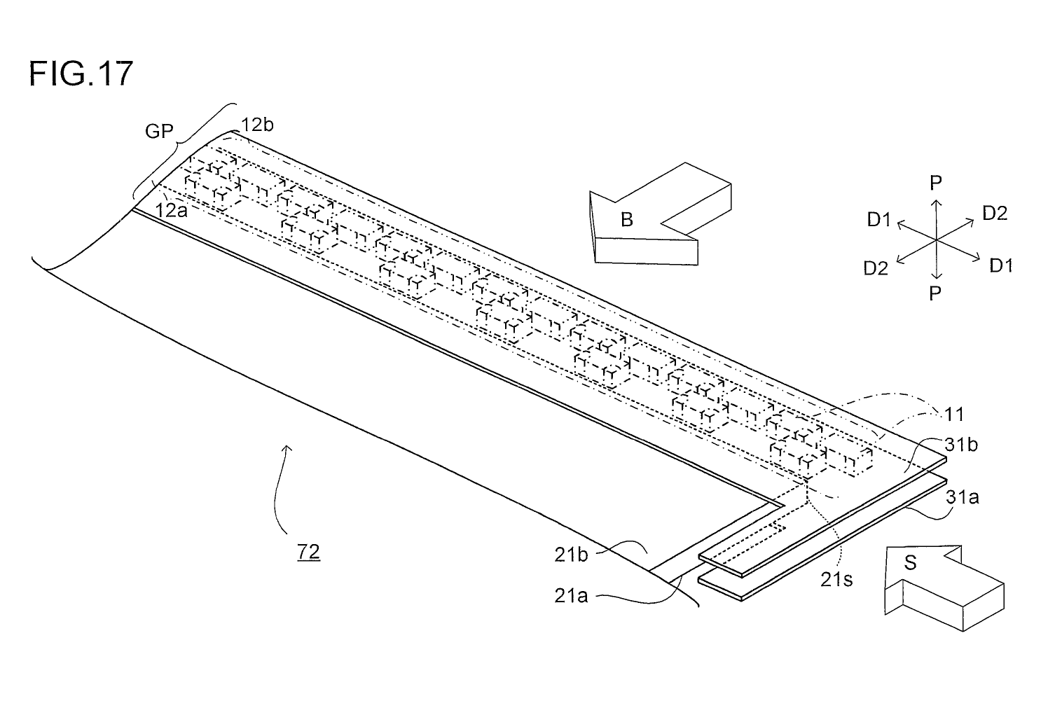

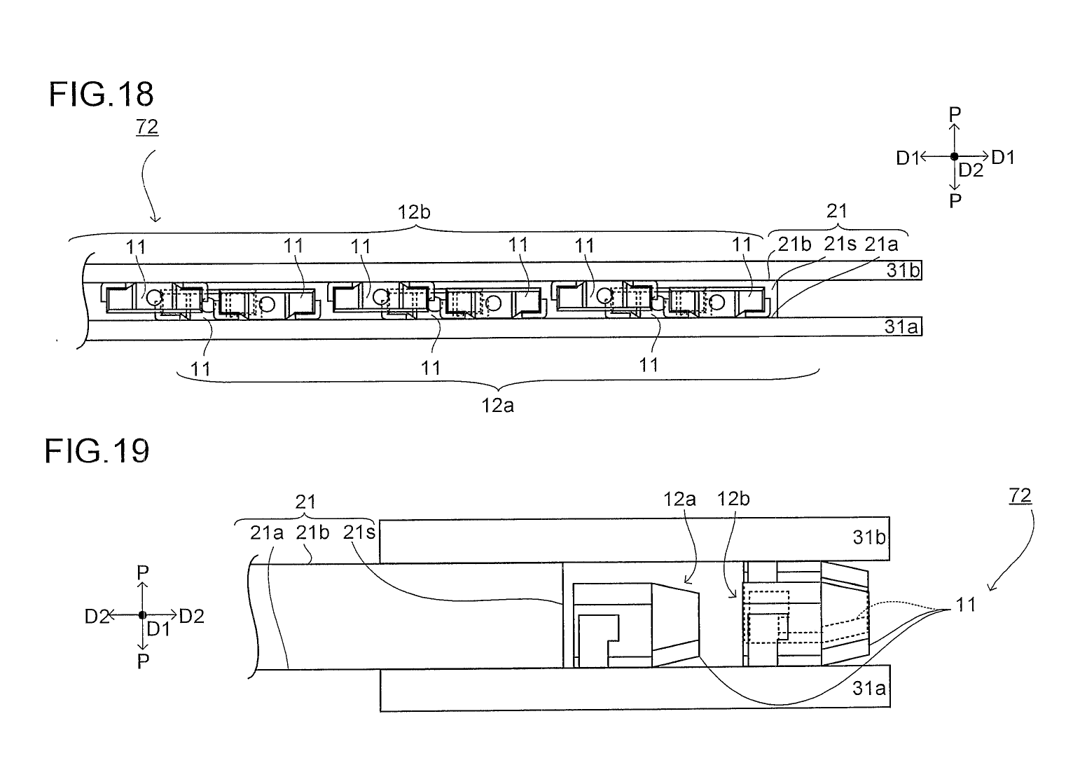

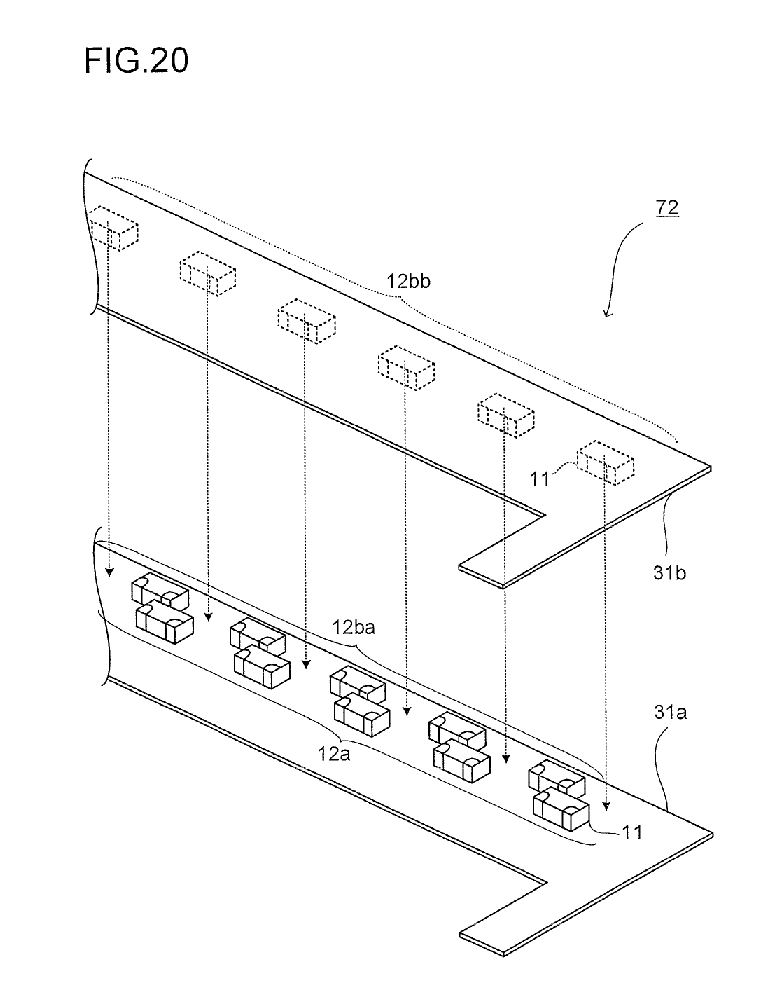

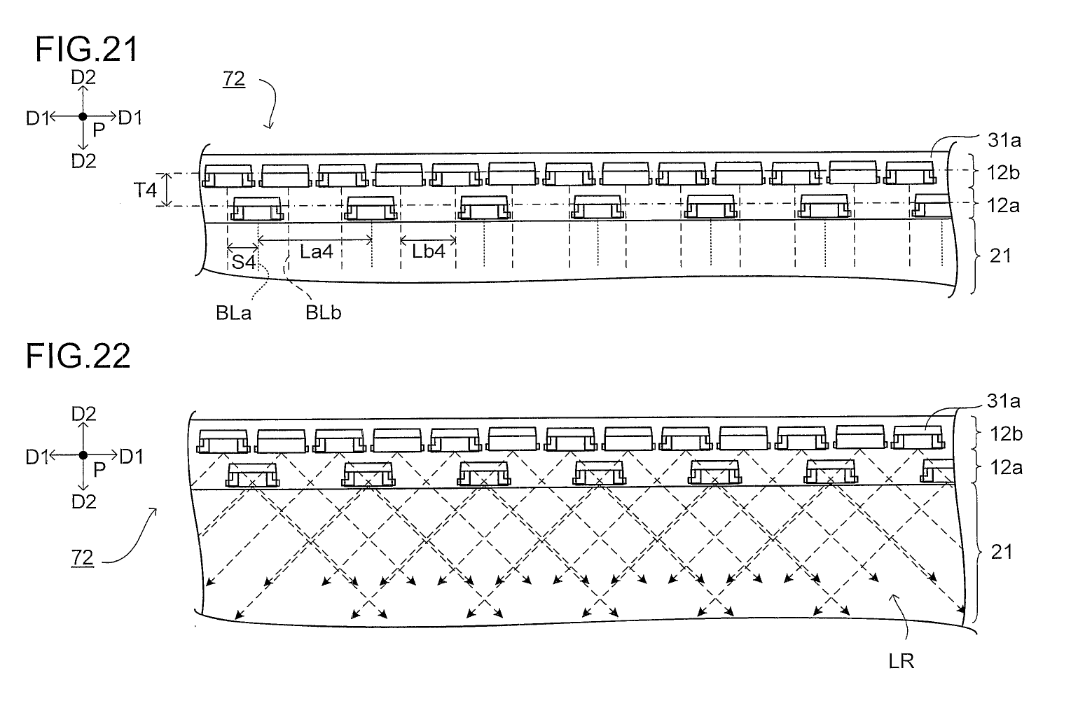

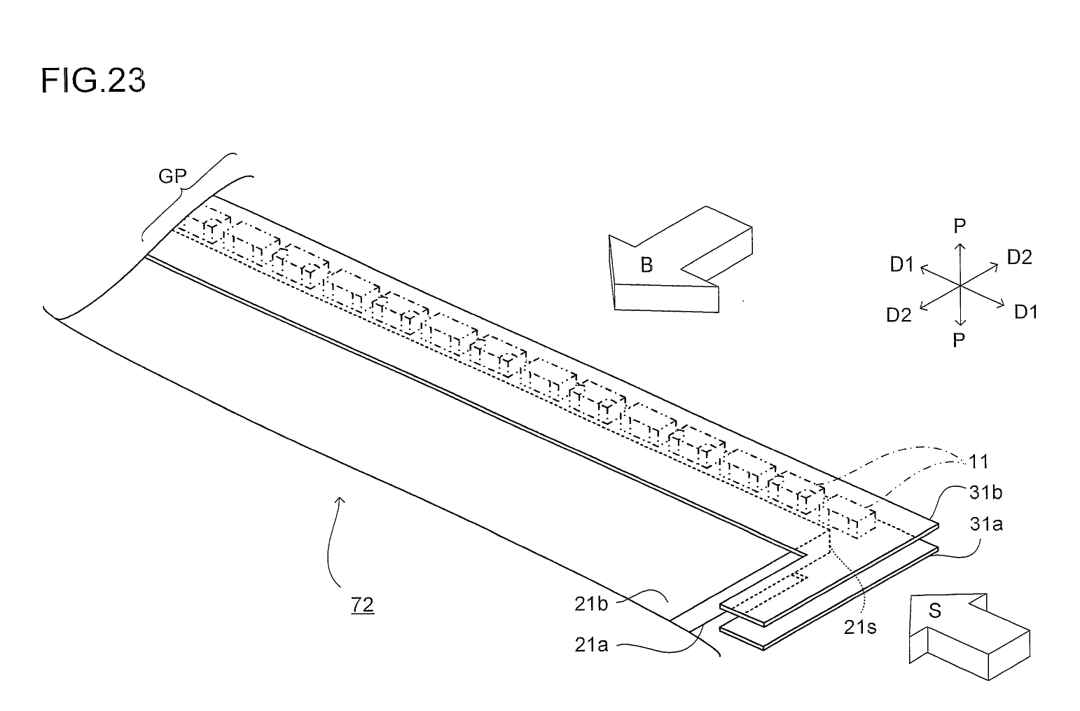

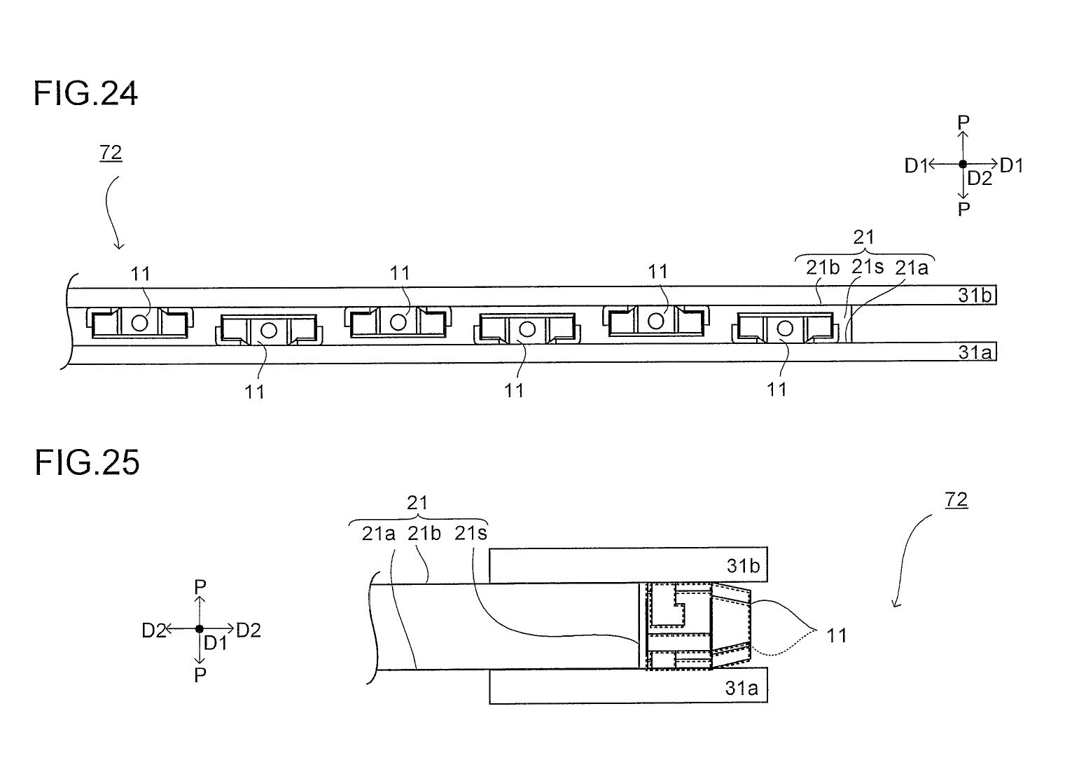

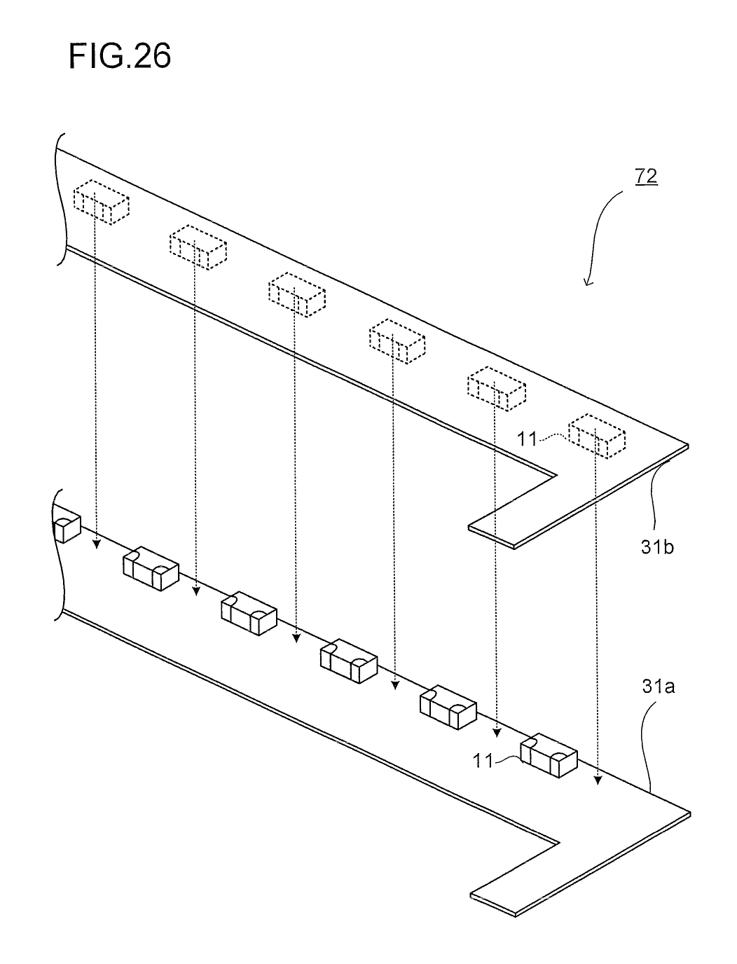

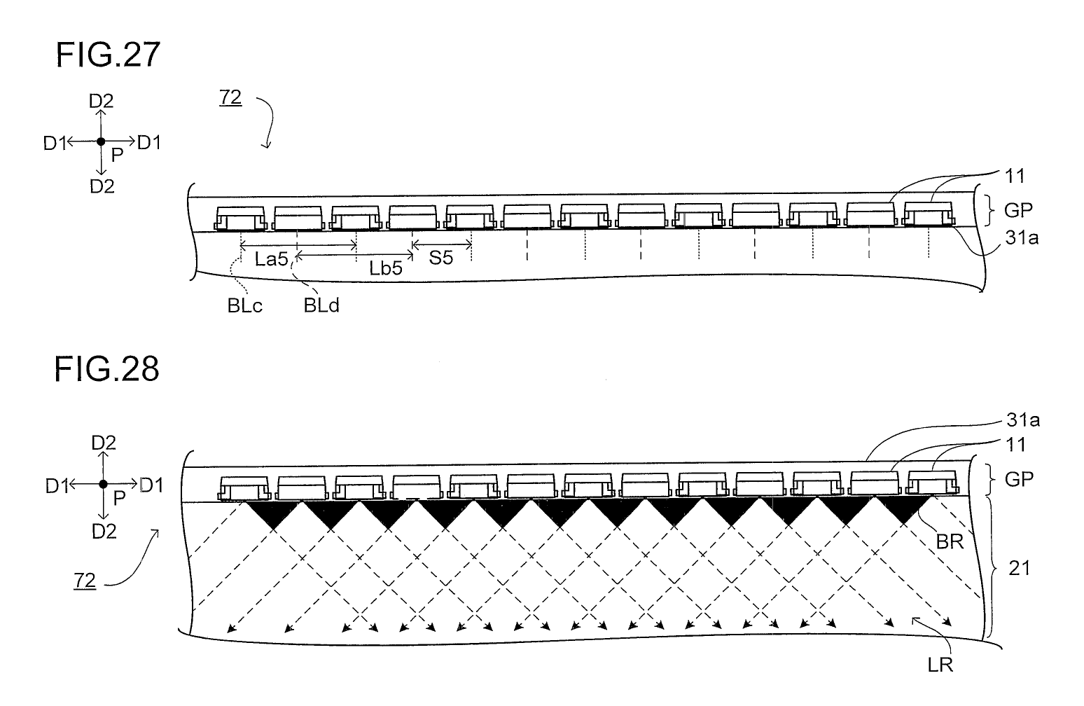

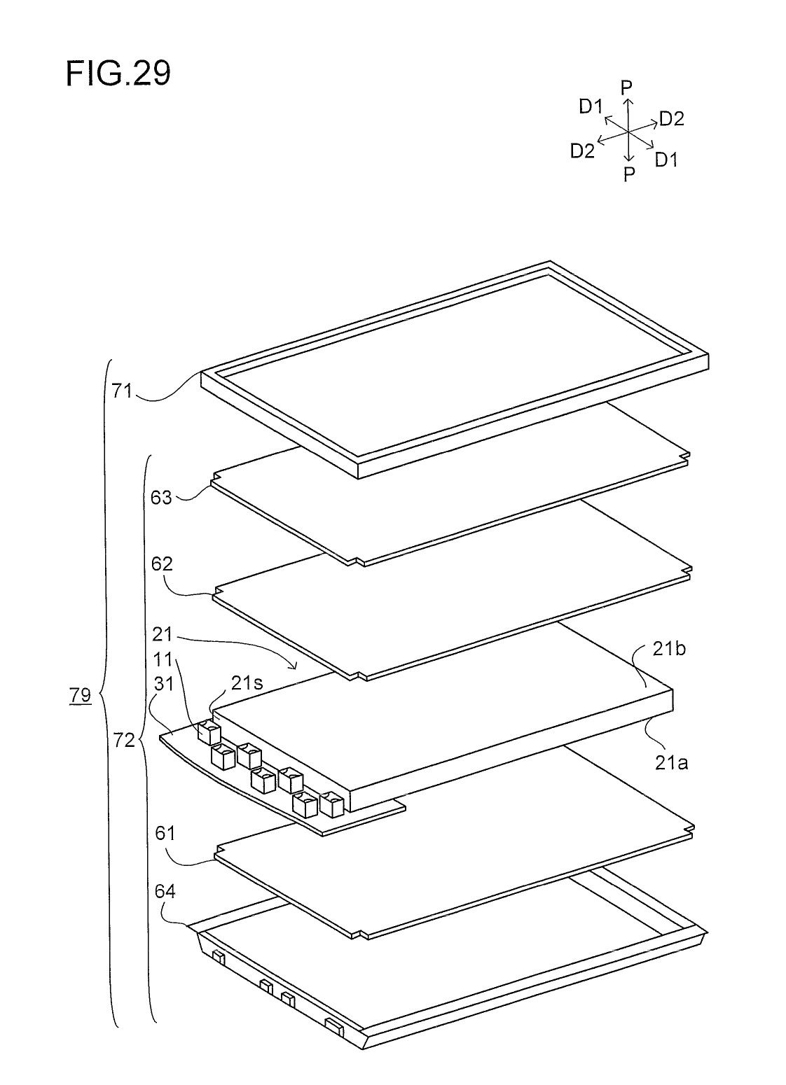

### BRIEF DESCRIPTION OF DRAWINGS

[FIG. 1] An enlarged perspective view of an area in the vicinity of LEDs and a FPC board shown in FIG. 29 (embodiment 1);

[FIG. 2] A plan view as seen from the back surface of the LEDs shown in FIG. 1;

[FIG. 3] A plan view as seen from the side surface of the LEDs shown in FIG. 1;

[FIG. 4] A ray diagram showing the optical paths of the LEDs in an LED group shown in FIG. 1;

[FIG. 5] A plan view showing how light emitted by the LEDs in the LED group shown in FIG. 1 travels;

[FIG. 6] An enlarged perspective view of an area in the vicinity of LEDs and a FPC board in the backlight unit of embodiment 2;

[FIG. 7] A plan view as seen from the back surface of the LEDs shown in FIG. 6;

[FIG. 8] A plan view as seen from the side surface of the LEDs shown in FIG. 6;

[FIG. 9] A ray diagram showing the optical paths of the LEDs in an LED group shown in FIG. 6;

[FIG. 10] A plan view showing how light emitted by the LEDs in the LED group shown in FIG. 6 travels;

[FIG. 11] An enlarged perspective view of an area in the vicinity of LEDs and FPC boards in the backlight unit of embodiment 3;

[FIG. 12] A plan view as seen from the back surface of the LEDs shown in FIG. 11;

[FIG. 13] A plan view as seen from the side surface of the LEDs shown in FIG. 11;

[FIG. 14] An exploded perspective view of FIG. 11;

[FIG. 15] A ray diagram showing the optical paths of the LEDs in an LED group shown in FIG. 11;

[FIG. 16] A plan view showing how light emitted by the LEDs in the LED group shown in FIG. 11 travels;

[FIG. 17] An enlarged perspective view of an area in the vicinity of LEDs and FPC boards in the backlight unit of embodiment 4;

[FIG. 18] A plan view as seen from the back surface of the LEDs shown in FIG. 17;

[FIG. 19] A plan view as seen from the side surface of the LEDs shown in FIG. 17;

[FIG. 20] An exploded perspective view of FIG. 17;

[FIG. 21] A ray diagram showing the optical paths of the LEDs in an LED group shown in FIG. 17;

[FIG. 22] A plan view showing how light emitted by the LEDs in the LED group shown in FIG. 17 travels;

[FIG. 23] An enlarged perspective view of an area in the vicinity of LEDs and FPC boards in the backlight unit of embodiment 5;

[FIG. 24] A plan view as seen from the back surface of the LEDs shown in FIG. 23;

[FIG. 25] A plan view as seen from the side surface of the LEDs shown in FIG. 23;

[FIG. 26] An exploded perspective view of FIG. 23;

[FIG. 27] A ray diagram showing the optical paths of the LEDs in an LED group shown in FIG. 23;

[FIG. 28] A plan view showing how light emitted by the LEDs in the LED group shown in FIG. 23 travels;

[FIG. 29] An exploded perspective view of a liquid crystal display;

[FIG. 30] An enlarged perspective view of an area in the vicinity of LEDs and a FPC board in a conventional backlight unit;

[FIG. 31] A plan view as seen from the back surface of the LEDs shown in FIG. 30;

[FIG. 32] A plan view as seen from the side surface of the LEDs shown in FIG. 30;

[FIG. 33] A plan view showing how light emitted by the LEDs shown in FIG. 30 travels;

[FIG. 34] An enlarged perspective view of an area in the vicinity of LEDs and a FPC board in a conventional backlight unit different from that shown in FIG. 30; and

[FIG. 35] A plan view showing how light emitted by the LEDs shown in FIG. 34 travels.

### LIST OF REFERENCE SYMBOLS

GP LED group

11 LED (light-emitting element)

12 LED row

12a LED row (one light-emitting element row or another light-emitting element row)

12b LED row (one light-emitting element row or another light-emitting element row)

21 Light guide plate

21a Bottom surface of the light guide plate (non-light-emitting surface of the light guide plate)

21b Top surface of the light guide plate (light-emitting surface of the light guide plate)

21s Side surface of the light guide plate (incident surface of the light guide plate)

31 FPC board (board)

31a FPC board (board facing the non-light-emitting surface of the light guide plate)

31b FPC board (board facing the light-emitting surface of the light guide plate)

La (La1 to La5) Pitch between LEDs

La (Lb1 to Lb5) Pitch between LEDs

BL Optical path of LEDs

BLa First optical path

BLb Second optical path

BLc Third optical path

BLd Fourth optical path

D1 First direction (direction of LED row)

D2 Second direction (direction intersecting the incident surface of the light guide plate)

71 Liquid crystal display panel

72 Backlight unit

79 Liquid crystal display

### BEST MODE FOR CARRYING OUT THE INVENTION

### Embodiment 1

An embodiment will be described below with reference to the accompanying drawings. For convenience, component symbols or the like may be omitted depending on the drawing; in this case, reference is made to other drawings. A black circle shown in the drawing represents a direction perpendicular to the plane of the drawing.

FIG. 29 is an exploded perspective view of a liquid crystal display 79. As shown in the figure, the liquid crystal display 79 includes a liquid crystal display panel 71 and a backlight unit 72.

The liquid crystal display panel 71 is a non-light-emitting display panel, and receives light (backlight) from the backlight unit 72 to perform a display function. Thus, if the light from the backlight unit 72 can be evenly distributed over the entire surface of the liquid crystal panel 71, the display quality of the liquid crystal panel 71 is enhanced.

In order to generate backlight, the backlight unit 72 includes LEDs (light-emitting diode) 11, a light guide plate 21, a reflective sheet 61, a diffusion sheet 62, an optical sheet 63 and a bezel 64.

The LEDs (light-emitting element) 11 are a point light source, and emit light to a side surface 21s of the light guide plate 21. The LEDs 11 are mounted on a FPC (flexible printed circuit) board 31 and thus receive the supply of current. In order to acquire a larger amount of light, a plurality of LEDs 11 are preferably used. (The arrangement of the LEDs 11 will be described in detail later.) For convenience, in the drawing, some of the LEDs 11 are only shown.

The light guide plate 21 is a plate-like member having side surfaces 21s and the bottom surface 21a and the top surface 21b that are located to sandwich the side surfaces 21s. One (an incident surface 21s) of the side surfaces 21s faces (points to) the light-emitting surface of the LEDs 11 to receive light from the LEDs 11. The received light is mixed within the light guide plate 21, and planar light is emitted from the top surface 21b.

The reflective sheet 61 is located to be covered by the light guide plate 21. The surface thereof that faces the bottom surface 21a of the light guide plate 21 is a reflective surface. Thus, the reflective surface reflects the light from the LEDs 11 and light passing through the light guide plate 21 to return it to the light guide plate 21 without leakage.

The diffusion sheet 62 is located to cover the light guide plate 21, and diffuses the planar light from the light guide plate 21 to distribute it over the entire liquid crystal display panel 71.

The optical sheet 63 is a lens sheet that has, for example, a lens shape in a sheet surface and that has an emission property to deflect light (focus light); the optical sheet 63 is located to cover the diffusion sheet 62. Hence, the light emitted from the diffusion sheet 62 enters the optical sheet 63 to converge, and this improves light-emission brightness per unit area.

The bezel 64 is a box-like member and accommodates the LEDs 11, the reflective sheet 61, the light guide plate 21, the diffusion sheet 62, the optical sheet 63 and the like. In particular, the reflective sheet 61, the light guide plate 21, the diffusion sheet 62 and the optical sheet 63 are sequentially stacked on the bottom of the bezel 64 in this order. The direction in which they are stacked in this way is hereinafter referred to as a stacking direction P. (The stacking direction P coincides with the thickness direction of the light guide plate 21.)

Here, the arrangement of the LEDs 11 will be described in detail with reference to FIGS. 1 to 5. FIG. 1 is an enlarged perspective view of an area in the vicinity of the LEDs 11 and the FPC board 31 (which is also hereinafter represented by the reference numeral 31a) shown in FIG. 29. FIG. 2 is a plan view as seen from the back surface of the LEDs 11 shown in FIG. 1 (see arrow “B”); FIG. 3 is a plan view as seen from the side surface of the LEDs 11 shown in FIG. 1 (see arrow “S”).

As shown in these figures, on the FPC board 31, a plurality of LEDs 11 are brought close to each other to foam a group. (An LED group GP is formed.) Specifically, two rows of LEDs [LED rows 12 (LED rows 12a and 12b)] arranged in one direction (called the first direction D1) are brought together to form a group of LEDs 11.

A plurality of LEDs 11 are arranged in the longitudinal direction of one side surface (the incident surface 21s) of the light guide plate 21 to form the LED rows 12a and 12b. (In other words, the longitudinal direction of the incident surface 21s coincides with the first direction D1.)

In the LED group GP, the two LED rows 12a and 12b are arranged in a direction (called the second direction D2) that intersects the incident surface 21s, for example, in a direction perpendicular to the incident surface 21s. (Specifically, the second direction D2 is also a direction that intersects the first direction D1.) In this arrangement, the number of LEDs 11 in front of the incident surface 21s of the light guide plate 21 increases with the number of LED rows 12a and 12b.

Generally, when a plurality of LEDs 11 are arranged in an row, the LEDs 11 can only be brought close to each other until the space therebetween is equal to a given space due to restrictions on the mounting performed on the FPC board 31. Thus, it is impossible to bring the LEDs 11 in full contact with each other and arrange them in one direction in order to increase the number of LEDs 11 in front of the incident surface 21s of the light guide plate 21.

However, the LED group GP includes the LED rows 12a and 12b in which the

LEDs 11 are located closest to each other to form rows. Thus, the total number of LEDs 11 in the LED group GP is increased. Consequently, it is possible for the backlight unit 72 to increase the amount of backlight (to increase the brightness of the backlight).

Moreover, since the LED row 12a and the LED row 12b are arranged in the direction that intersects the incident surface 21s of the light guide plate 21, the degree to which the LEDs 11 in the LED group GP are brought close to each other is increased as compared with the degree to which LEDs in an LED group including only one LED row are brought close to each other. Hence, the dark region produced between the LEDs 11 is more likely to be small, and variations in brightness of backlight are unlikely to occur.

In particular, in the backlight unit 72, as shown in the ray diagram of FIG. 4, a pitch La1 between the LEDs 11 in the LED row 12a is equal to a pitch Lb1 between the LEDs 11 in the LED row 12b. (La1=Lb1.) The optical paths (the first optical paths BLa) of the LEDs 11 in the LED row 12a and the optical paths (the second optical paths BLb) of the LEDs 11 in the LED row 12b are alternately arranged in the first direction Dl.

In this case, in the two LED rows 12a and 12b, one LED 11 in the LED row 12b apart from the incident surface 21s of the light guide plate 21 emits light between the LEDs 11 in the LED row 12a close to the incident surface 21s of the light guide plate 21.

Thus, as shown in FIG. 5 (a plan view showing light emitted from the LEDs 11), the dark regions produced between the LEDs 11 in the LED row 12a are eliminated. This is because the regions between the LEDs 11 in the LED row 12a are illuminated by the LEDs 11 in the LED row 12b such that they become the light regions LR.

Hence, in the backlight unit 72, the two types of regions, namely, the dark region and the light region are not produced on the incident surface 21s of the light guide plate 21; the one type of region, the light region LR, is only produced. Thus, variations in brightness caused by the presence of the two types of regions, namely, the dark region and the light region, are not produced.

### Embodiment 2

Embodiment 2 will be described. Components having the same function as those used in embodiment 1 are identified with common symbols, and their description will not be repeated.

In embodiment 1, the backlight unit 72, where, in the two LED rows 12a and 12b, one LED 11 in the LED row 12b emits light between the LEDs 11 in the LED row 12a is described by way of example. However, no restrictions are imposed by this.

For example, as shown in FIGS. 6 to 10 (FIGS. 6 to 10 are similar in expression to FIGS. 1 to 5.), there may be provided a backlight unit 72 in which two LEDs 11 in the LED row 12b emit light between LEDs 11 in the LED row 12a.

Specifically, a pitch La2 between the LEDs 11 in the LED row 12a is different from a pitch Lb2 between the LEDs 11 in the LED row 12b. (La2>Lb2.); the first optical paths BLa of the LEDs 11 in the LED row 12a and the second optical paths BLb of the LEDs 11 in the LED row 12b are arranged in the first direction D1. The arranged optical paths include portions in which the optical paths of the same type (the second optical path BLb) are successively aligned (see FIG. 9).

Even in such a backlight unit 72, since the two LED rows 12a and 12b arranged in the direction (the second direction D2) that intersects the incident surface 21s are included in the LED group GP, the total number of LEDs 11 is increased. Thus, in the backlight unit 72, the brightness of backlight is enhanced.

In the backlight unit 72 incorporating the two LED rows 12a and 12b, the dark region BR produced between the LEDs 11 in the LED row 12a is reduced as compared with the dark region produced between LEDs in a backlight unit incorporating only one LED row (see FIG. 10). Hence, variations in brightness caused by the presence of the two types of regions, namely, the dark region BR and the light region LR, are reduced.

### Embodiment 3

Embodiment 3 will be described. Components having the same function as those used in embodiment 1 are identified with common symbols, and their description will not be repeated.

In the backlight unit 72 of embodiments 1 and 2, on the FPC board 31 facing only the bottom surface 21a (the non-light-emitting surface 21a) of the light guide plate 21, the LED group GP is mounted. However, no restrictions are imposed by this. For example, as shown in FIGS. 11 to 16, on FPC boards 31a and 11h facing the bottom surface 21a and the top surface 21b (the light-emitting surface 21b) of the light guide plate 21, the LEDs 11 in the LED group GP may be mounted in a distributed manner.

A backlight unit 72 in which, on the FPC board (non-light-emitting-surface-side FPC board) 31a facing the bottom surface 21a of the light guide plate 21 and the FPC board (light-emitting-surface-side FPC board) 31b facing the top surface 21b, the LED row 12a and the LED row 12b in the LED group GP are respectively mounted will be described below.

FIGS. 11 to 13 are similar in expression to FIGS. 1 to 3. In FIG. 11, LEDs 11 mounted on the FPC board 31a are represented by dashed-dotted lines, and LEDs 11 mounted on the FPC board 31b are represented by dashed-two dotted lines.

FIG. 14 is an exploded perspective view of FIG. 11. Dotted-line arrows shown in FIG. 14 represent, when the two FPC boards 31a and 31b are brought close to each other, the movement paths of the LEDs 11 on the FPC board 31b. FIGS. 15 and 16 are similar in expression to FIGS. 4 and 5. (For convenience, in FIGS. 15 and 16, the FPC board 31b is omitted.)

As shown in FIGS. 11 to 14, especially FIG. 14, the LED row 12a is mounted on the FPC board 31a facing (pointing to) the bottom surface 21a of the light guide plate 21. On the other hand, the LED row 12b is mounted on the FPC board 31b facing the top surface 21b of the light guide plate 21. When the FPC board 31a and the FPC board 31b approach each other so as to sandwich the light guide plate 21, the LED row 12a and the LED row 12b are arranged in the direction (the second direction) that intersects the incident surface 21s (see FIG. 11).

As shown in FIG. 15, a pitch La3 between the LEDs 11 in the LED row 12a is equal to a pitch Lb3 between the LEDs 11 in the LED row 12b. (La3=Lb3.); the first optical paths BLa of the LEDs 11 in the LED row 12a and the second optical paths BLb of the LEDs 11 in the LED row 12b are alternately arranged in the first direction D1, as in embodiment 1.

However, the space S1 between the first optical path BLa and the second optical path BLb in embodiment 1 (see FIG. 4) is different from the space S3 between the first optical path BLa and the second optical path BLb in embodiment 3. The space T1 between the LED row 12a and the LED row 12b in embodiment 1 (see FIG. 4) is also different from the space T3 between the LED row 12a and the LED row 12b in embodiment 3.

In the backlight unit 72 of embodiment 1, priority is given to producing no dark regions on the incident surface 21s of the light guide plate 21, and the space T1 and the space S3 are set accordingly. Since, in this setting, the space T1 is relatively large, it is possible to mount the LED row 12a and the LED row 12b on only the FPC board 31a facing the bottom surface 21a of the light guide plate 21. This mounting, however, causes the space T1 to become relatively large, and thus the depth of the FPC board 31 is extended, with the result that the size of the backlight unit 72 is increased.

On the other hand, in the backlight unit 72 of embodiment 3, even if some dark region BR is produced on the incident surface 21s of the light guide plate 21, priority is given to reducing the size of the backlight unit 72, and thus the space T3 and the space S3 are set accordingly. Since, in this setting, the space T3 is relatively small, it is impossible to mount the LED row 12a and the LED row 12b on only the FPC board 31a facing the bottom surface 21a of the light guide plate 21. _Hence, the LED row 12a and LED row 12b are mounted on the two FPC boards 31a and 31b, respectively.

Even in the backlight unit 72 of embodiment 3, the dark region BR produced between the LEDs 11 in the LED row 12a is reduced as compared with the dark region produced between LEDs in a backlight unit incorporating only one LED row (see FIG. 16). Thus, variations in brightness caused by the presence of the two types of regions, namely, the dark region BR and the light region LR, are reduced.

There are two methods: one method is to mount, as in embodiment 1, the LED rows 12a and 12b on only the FPC board 31 facing the bottom surface 21a of the light guide plate 21 (or one method is to mount the two LED rows on only the FPC board facing the top surface 21b of the light guide plate 21); and the other method is to respectively mount, as in embodiment 3, the LED rows 12a and 12b on the FPC board 31a facing the bottom surface 21a of the light guide plate 21 and the FPC board 31b facing the top surface 21b. This increases the number of choices (flexibility) for the mounting corresponding to the desired design (with priority given to, for example, reducing variations in brightness or achieving size reduction) of the backlight unit 72.

Generally, when, as in embodiment 1, the LED row 12a and the LED row 12b are arranged in the second direction D2 of the FPC board 31 facing the bottom surface 21a of the light guide plate 21 (or when the two LED rows are mounted in the second direction D2 of the FPC board 21b facing the top surface 21b of the light guide plate 21), the LED rows 12a and 12b can only approach each other until the space therebetween is equal to a given space due to restrictions on the mounting.

However, when, as in embodiment 3, the LED row 12a and the LED row 12b are respectively mounted on the FPC board 31a facing the bottom surface 21a of the light guide plate 21 and the FPC board 31b facing the top surface 21b of the light guide plate 21, the space between the LED row 12a and the LED row 12b when they approaches each other is not affected by the mounting. Thus, it is possible to relatively reduce the space T3 between the LED row 12a and the LED row 12b in embodiment 3. (When embodiment 3 is compared with embodiment 1, T3<T1; see FIGS. 4 and 15.)

In the above description, the backlight unit 72 including the FPC board 31a facing the bottom surface 21a of the light guide plate 21 and the FPC board 31b facing the top surface 21b of the light guide plate 21 is discussed by way of example. However, no restrictions are imposed by the case where the FPC board 31a and the FPC board 31b are separate from each other.

In other words, the FPC board 31a may be continuous with the FPC board 31b. Such a unit in which the FPC board 31a is continuous and integrated with the FPC board 31b is referred to as a FPC board unit (board unit).

The FPC board unit winds around the bottom surface 21a and the top surface 21b of the light guide plate 21 (In order to sandwich the bottom surface 21a and the top surface 21b of the light guide plate 21, the FPC board unit has portions that are flexible to be bent), and thus the mounting surface of the FPC board 31a faces the bottom surface 21a and the mounting surface of the FPC board 31b faces the top surface 21b.

### Embodiment 4

Embodiment 4 will be described. Components having the same function as those used in embodiments 1 to 3 are identified with common symbols, and their description will not be repeated.

In the backlight unit 72 of embodiment 3, the LED rows 12a and 12b are mounted on the FPC board 31a and the FPC board 31b, respectively. However, no restrictions are imposed by this. Specifically, when the LEDs 11 are distributed and mounted on the FPC board 31a and the FPC board 31b, it is unnecessary to arrange the LEDs 11 in a row on each of the FPC boards 31a and 31b.

A backlight unit 72 in which LEDs 11 mounted on the separate boards (the FPC boards 31a and 31b) are mixed and aligned to form the LED row 12b will be described below with reference to FIGS. 17 to 22. FIGS. 17 to 22 are similar in expression to FIGS. 11 to 16.

As shown in FIGS. 17 to 20, especially FIG. 20, the LED row 12a is mounted on the FPC board 31a. On the FPC board 31a, a plurality of LEDs 11 are aligned in a location farther away from the incident surface 21s of the light guide plate 21 than the LED row 12a.

The aligned LEDs 11 are part of the LED row 12b and are referred to as a partial LED row 12ba. (Specifically, on the FPC board 31a, the LED row 12a and the partial LED row 12ba are arranged in the second direction D2.) On the other hand, a plurality of LEDs 11, other than the partial LED row 12ba, that constitute the LED row 12b are mounted on the FPC board 31b and are referred to as a partial LED row 12bb.

When the FPC board 31a and the FPC board 31b approach each other so as to sandwich the light guide plate 21, the LEDs 11 in the partial LED row 12ba on the FPC board 31a engage with the LEDs 11 in the partial LED row 12bb on the FPC board 31b (in other words, the LEDs 11 in the partial LED row 12ba and the LEDs 11 in the partial LED row 12bb are alternatively arranged), with the result that the LED row 12b, which is arranged in a row, is completed.

Consequently, in front of the incident surface 21s of the light guide plate 21, the LED row 12a is located, and, behind the LED row 12a (on the side farther away from the incident surface 21s), the LED row 12b is located. That is, the LED row 12a and the LED row 12b are arranged in the direction (the second direction D2) that intersects the incident surface 21s of the light guide plate 21.

As shown in FIG. 21, in the backlight unit 72 including these LED rows 12a and 12b, as in embodiment 2, a pitch La4 between the LEDs 11 in the LED row 12a is different from a pitch Lb4 between the LEDs 11 in the LED row 12b. (La4>Lb4.). The first optical paths BLa of the LEDs 11 in the LED row 12a and the second optical paths BLb of the LEDs 11 in the LED row 12b are arranged in the first direction D1; the arranged optical paths include portions in which the optical paths of the same type (the second optical path BLb) are successively aligned.

The pitch Lb4 in the LED row 12b in embodiment 4 is different from the pitch Lb2 in the LED row 12b in embodiment 2. (Lb4<Lb2; see FIGS. 21 and 9.)

Generally, when a plurality of LEDs 11 are arranged in an row, due to restrictions on the mounting performed on the FPC board 31, the LEDs 11 can only be brought close to each other until the space therebetween is equal to a given space. However, the LEDs 11 in the LED row 12b are distributed and mounted on the FPC board 31a and the FPC board 31b.

Thus, even if the space between the LEDs 11 on each of the FPC boards 31a and 31b is wide due to restrictions on the mounting, the space between the LEDs 11 in the LED row 12b is unaffected by the mounting and is thus narrow. Hence, in embodiment 4, the pitch Lb4 in the LED row 12b is relatively narrow. Since, as shown in FIGS. 21 and 22, the pitch Lb4 is relatively narrow, the dark regions caused by the relatively wide pitch Lb2 in embodiment 2 are eliminated (see FIG. 10).

When the pitch La4 between the LEDs 11 in the LED row 12a is set according to the relatively narrow pitch Lb4, the space S4 between the first optical path BLa of the LED 11 in the LED row 12a and the second optical path BLb of the LED 11 in the LED row 12b becomes relatively narrow (for example, S4<S2; see FIGS. 21 and 9). Thus, in front of the incident surface 21s of the light guide plate 21, the LED group GP including a relatively large number of LEDs 11 is located, with the result that the brightness of the backlight unit 72 is enhanced.

Specifically, when the LEDs 11 mounted on the separate boards (the FPC boards 31a and 31b) are mixed and aligned to form the LED row 12b, it is possible to significantly reduce the pitch Lb4 in the LED row 12b. This increases the number of choices for the mounting corresponding to the desired design of the backlight unit 72. Since the pitch Lb4 is significantly reduced, the number of LEDs 11 is more likely to be increased, and the brightness of the backlight unit 72 is enhanced accordingly.

In the above description, the backlight unit 72 including the FPC board 31a facing the bottom surface 21a of the light guide plate 21 and the FPC board 31b facing the top surface 21b of the light guide plate 21 is discussed by way of example. However, no restrictions are imposed by the case where the FPC board 31a and the FPC board 31b are separate from each other. In other words, a FPC board unit in which the FPC board 31a is continuous with the FPC board 31b may be used.

### Embodiment 5

Embodiment 5 will be described. Components having the same function as those used in embodiments 1 to 4 are identified with common symbols, and their description will not be repeated.

In the backlight unit 72 of embodiments 1 to 4, the LED group GP includes the two LED rows 12a and 12b. However, it is not always necessary for the LED group GP to include the two LED rows 12a and 12b. This is because, even with a backlight unit 72 including only one LED row, it is possible to reduce variations in brightness and achieve size reduction.

Such a backlight unit 72 will be described with reference to FIGS. 23 to 28. FIGS. 23 to 28 are similar in expression to FIGS. 11 to 16.

As shown in FIGS. 23 to 26, especially FIG. 26, the LEDs 11 included in the LED group GP are distributed on the FPC board 31a facing the bottom surface 21a of the light guide plate 21 and the FPC board 31b facing the top surface 21b, and are mounted in a row on each of the FPC boards 31a and 31b [a pitch La5 between the LEDs 11 arranged in a row on the FPC board 31a is equal to a pitch Lb5 between the LEDs 11 arranged in a row on the FPC board 31b. (La5=Lb5.)]

The FPC board 31a and the FPC board 31b are brought close to each other with their mounting surfaces opposite each other, and thus the LEDs 11 arranged in a row on the FPC board 31a and the LEDs 11 arranged in a row on the FPC board 31b are alternately arranged [the optical paths (the third optical path BLc) of the LEDs 11 on the FPC board 31a and the optical paths (the fourth optical path BLd) of the LEDs 11 on the FPC board 31b are alternately aligned; see FIG. 27.]

In particular, as shown in FIG. 23, the LEDs 11 on the FPC board 31a and the LEDs 11 on the FPC board 31b are alternately arranged in the first direction in a row.

As described in embodiment 4, generally, when a plurality of LEDs 11 are arranged in an row, due to restrictions on the mounting performed on the FPC board 31, the LEDs 11 can only be brought close to each other until the space therebetween is equal to a given space. However, in this embodiment, the LED group GP is linear, and the LEDs 11 in the linear LED group GP are distributed and mounted on the FPC board 31a and the FPC board 31b.

Thus, even when the space between the LEDs 11 on each of the FPC boards 31a and 31b is wide due to restrictions on the mounting, if a plurality of LEDs 11 on the FPC board 31a engage with a plurality of LEDs 11 on the FPC board 31b to form the linear LED group GP, the space between the LEDs 11 in the LED group GP is unaffected by the mounting and is thus narrow.

Hence, in such a backlight unit 72, the space between the LEDs 11 in the LED group GP is significantly narrow, and the total number of LEDs 11 is increased. Thus, the brightness of backlight in the backlight unit 72 is enhanced.

In the backlight unit 72 incorporating the LED group GP in which the LEDs 11 are very closely arranged in a row, the dark regions BR produced between the LEDs 11 are naturally reduced (see FIG. 28). Thus, variations in brightness caused by the presence of the two types of regions, namely, the dark region BR and the light region LR, are reduced.

In the above description, as in embodiments 3 and 4, the backlight unit 72 including the FPC board 31a facing the bottom surface 21a of the light guide plate 21 and the FPC board 31b facing the top surface 21b of the light guide plate 21 is discussed by way of example. However, no restrictions are imposed by the case where the FPC board 31a and the FPC board 31b are separate from each other. In other words, a board unit in which the FPC board 31a is continuous with the FPC board 31b may be used.

A backlight unit 72 in which the LEDs 11 on the FPC board 31a and the LEDs 11 on the FPC board 31b that are alternately arranged are disposed not in a row but in a zigzag pattern is said to be similar to the backlight unit 72 of embodiment 3.

### Other Embodiments

The present invention is not limited to the embodiments described above; many modifications are possible without departing from the spirit of the invention.

For example, in the backlight unit 72 of embodiment 4, the LEDs 11 mounted on the FPC board 31a and the FPC board 31b are mixed and aligned to form the LED row 12b (see FIG. 17).

However, no restrictions are imposed by this. For example, the LEDs 11 mounted on the FPC board 31a and the FPC board 31b may be mixed and aligned to form the LED row 12a or to form both the LED row 12a and the LED row 12b.

In other words, at least one of the LED row 12a and the LED row 12b is preferably formed by mixing and aligning the LEDs 11 mounted on the separate boards (the FPC boards 31a and 31b).

In the backlight unit 72 of embodiment 4, the LED row 12b formed by mixing and aligning the LEDs 11 mounted on the FPC board 31a and the FPC board 31b is included, the second optical paths BLb of the LEDs 11 in the LED row 12b and the first optical paths BLa of the LEDs 11 in the LED row 12a are aligned and the aligned optical paths include portions in which the optical paths of the same type (the second optical path BLb) are successively aligned (see FIG. 21).

However, no restrictions are imposed by this. For example, the backlight unit 72 may be used in which at least one of the LED row 12a and the LED row 12b is formed by mixing and aligning the LEDs 11 mounted on the FPC board 31a and the FPC board 31b, and the pitch La between the LEDs 11 in the LED row 12a is equal to the pitch Lb between the LEDs 11 in the LED row 12b and thus the first optical paths BLa of the LEDs 11 in the LED row 12a and the second optical paths BLb of the LEDs 11 in the LED row 12b may be alternately aligned.

The point is that, irrespective of whether the LEDs 11 included in the LED rows 12a and 12b in the LED group GP are mounted on a single FPC board 31 or on a plurality of FPC boards 31, the first optical paths BLa of the LEDs 11 in the LED row 12a and the second optical paths BLb of the LEDs 11 in the LED row 12b may be alternately aligned.

Naturally, irrespective of whether the LEDs 11 included in the LED rows 12a and 12b in the LED group GP are mounted on a single FPC board 31 or on a plurality of FPC boards 31, the following configuration may be employed: the pitch La between the LEDs 11 in the LED row 12a is different from the pitch Lb between the LEDs 11 in the LED row 12b, the first optical paths BLa of the LEDs 11 in the LED row 12a and the second optical paths BLb of the LEDs 11 in the LED row 12b are aligned and the aligned optical paths include portions in which the optical paths of the same type (for example, the second optical path BLb) are successively aligned.

In the above description, when a plurality of LED rows 12 are included in the LED group GP, the examples in which the two LED rows 12 (12a and 12b) are employed are discussed. However, no restrictions are imposed by these examples. For example, three or more LED rows 12 may be included in the LED group GP.

The direction in which the LEDs 11 emit light is not limited to a direction perpendicular to the incident surface 21s of the light guide plate 21; it may be inclined to the incident surface 21s. For example, only the LEDs 11 located in the vicinity of the ends of the LED row 12a may be inclined not in the direction perpendicular to the incident surface 21s but may be inclined to face the center of the light guide plate 21. This is because the amount of light leaking from the side surfaces of the light guide plate 21 other than the incident surface 21s is reduced in this way.

1. A backlight unit that comprises: a light-emitting element group including a plurality of light-emitting elements; and a light guide plate having an incident surface which light from the light-emitting elements enters,
wherein the light-emitting element group includes a plurality of light-emitting element rows having the light-emitting elements aligned, and the plurality of light-emitting element rows are aligned in a direction intersecting the incident surface of the light guide plate.

2. The backlight unit of claim 1,
wherein, in the aligned light-emitting element rows, between the light-emitting elements in one of the light-emitting element rows, the light-emitting elements in another of the light-emitting element rows emit light.

3. The backlight unit of claim 2,
wherein a number of the light-emitting elements in the another of the light-emitting element rows that emit light between the light-emitting elements in the one of the light-emitting element rows is one.

4. The backlight unit of claim 3,
wherein, in the aligned light-emitting element rows, a pitch between the light-emitting elements in the one of the light-emitting element rows is equal to a pitch between the light-emitting elements in the another of the light-emitting element rows, and first optical paths of the light-emitting elements in the one of the light-emitting element rows and second optical paths of the light-emitting elements in the another of the light-emitting element rows are alternately aligned.

5. The backlight unit of claim 2,
wherein a number of the light-emitting elements in the another of the light-emitting element rows that emit light between the light-emitting elements in the one of the light-emitting element rows is more than one.

6. The backlight unit of claim 5,
wherein, in the aligned light-emitting element rows, a pitch between the light-emitting elements in the one of the light-emitting element rows is different from a pitch between the light-emitting elements in the another of the light-emitting element rows, first optical paths of the light-emitting elements in the one of the light-emitting element rows and second optical paths of the light-emitting elements in the another of the light-emitting element rows are aligned and the aligned optical paths include a portion where the optical paths of a same type are successively aligned.

7. The backlight unit of claim 2,
wherein a board on which the one of the light-emitting element rows is mounted and a board on which the another of the light-emitting element rows is mounted are separate from each other.

8. The backlight unit of claim 7,
wherein the board on which the one of the light-emitting element rows is mounted faces a light-emitting surface of the light guide plate, and the board on which the another of the light-emitting element rows is mounted faces a non-light-emitting surface opposite the light-emitting surface.

9. The backlight unit of claim 2,
wherein a continuous board unit includes a board on which the one of the light-emitting element rows is mounted and a board on which the another of the light-emitting element rows is mounted.

10. The backlight unit of claim 9,
wherein the board unit winds around a light-emitting surface of the light guide plate and a non-light-emitting surface opposite the light-emitting surface, and the board on which the one of the light-emitting element rows is mounted faces the light-emitting surface, and the board on which the another of the light-emitting element rows is mounted faces the non-light-emitting surface.

11. The backlight unit of claim 2,
wherein at least one of the one of the light-emitting element rows and the another of the light-emitting element rows is foamed by mixing and aligning light-emitting elements mounted on separate boards.

12. The backlight unit of claim 11,
wherein one of the separate boards faces a light-emitting surface of the light guide plate and the other of the separate boards faces a non-light-emitting surface opposite the light-emitting surface.

13. A backlight unit that comprises: a light-emitting element group including a plurality of light-emitting elements; and a light guide plate having an incident surface which light from the light-emitting elements enters,
wherein the light-emitting elements in the light-emitting element group are distributed on a light-emitting-surface-side board facing a light-emitting surface of the light guide plate and a non-light-emitting-surface-side board facing a surface opposite the light-emitting surface, and are mounted in a row on each of the boards, and the light-emitting-surface-side board and the non-light-emitting-surface-side board are brought close to each other with mounting surfaces thereof opposite each other such that the light-emitting elements on the light-emitting-surface-side board and the light-emitting elements on the non-light-emitting-surface-side board are alternately arranged.

14. The backlight unit of claim 13,
wherein the light-emitting elements on the light-emitting-surface-side board and the light-emitting elements on the non-light-emitting-surface-side board that are alternately arranged are disposed in a row.

15. The backlight unit of claim 13,
wherein a continuous board unit includes the light-emitting-surface-side board and the non-light-emitting-surface-side board.

16. A liquid crystal display comprising:
the backlight unit of claim 1; and
a liquid crystal display panel receiving light emitted from the backlight unit.
